(19) United States
(12) Patent Application Publication
(10) Pub. No.: US 2006/0168050 A1
(43) Pub. Date: Jul. 27, 2006

(54) Interface for creation of limited-use electronic mail accounts

(75) Inventors: Edward K. Y. Jung, Bellevue, WA (US); Royce A. Levien, Lexington, MA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/087,727

(22) Filed: Mar. 22, 2005

Related U.S. Application Data
(63) Continuation-in-part of application No. 11/041,894, filed on Jan. 21, 2005.
(63) Continuation-in-part of application No. 11/046,224, filed on Jan. 28, 2005.
(63) Continuation-in-part of application No. 11/066,728, filed on Feb. 25, 2005.

(51) Int. Cl. G06F 15/16

(52) U.S. Cl. 709/206; 709/246

(57) ABSTRACT

In one aspect, a method related to a limited-use electronic mail account. In addition to the foregoing, other method and system and program product aspects are described in the claims, drawings, and text forming a part of the present application.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending United States patent application entitled LIMITED-LIFE ELECTRONIC MAIL ACCOUNT AS INTERMEDIARY, naming Paul G. Allen; Edward K. Y. Jung; Royce A. Levien; Mark A. Malamud; and John D. Rinaldo, Jr. as inventors, U.S. application Ser. No. 11/041,894, filed Jan. 21, 2005.

2. For purposes of the USPTO extra-statutory requirements, the present application constitutes a continuation in part of currently co-pending United States patent application entitled LIMITED-LIFE ELECTRONIC MAIL ACCOUNTS naming Paul G. Allen; Edward K. Y. Jung; Royce A. Levien; Mark A. Malamud; and John D. Rinaldo, Jr. as inventors, U.S. application Ser. No. 11/046,224, filed Jan. 28, 2005, by express mail.

3. For purposes of the USPTO extra-statutory requirements, the present application constitutes a continuation in part of currently co-pending United States patent application entitled LIMITED-OPERATION ELECTRONIC MAIL ACCOUNTS WITH SET FUNCTIONS naming Paul G. Allen, Edward K. Y. Jung; Royce A. Levien; Mark A. Malamud; and John D. Rinaldo, Jr. as inventors, U.S. application Ser. No. 11/066,728 filed Feb. 25, 2005, by express mail.

### TECHNICAL FIELD

The present application relates, in general, to electronic mail.

### SUMMARY

In one aspect, a method related to electronic mail includes but is not limited to: displaying a limited-use electronic mail account interface to create a limited-use electronic mail account; and accepting input to the limited-use electronic mail account interface. In addition to the foregoing, other method aspects are described in the claims, drawings, and text forming a part of the present application.

In one aspect, a system related to electronic mail includes but is not limited to: circuitry for displaying a limited-use electronic mail account interface to create a limited-use electronic mail account; and circuitry for accepting input to the limited-use electronic mail account interface. In addition to the foregoing, other system aspects are described in the claims, drawings, and text forming a part of the present application.

In one or more various aspects, related systems include but are not limited to circuitry and/or programming and/or electro-mechanical devices and/or optical devices for effecting the herein-referenced method aspects; the circuitry and/or programming and/or electro-mechanical devices and/or optical devices can be virtually any combination of hardware, software, and/or firmware configured to effect the herein-referenced method aspects depending upon the design choices of the system designer skilled in the art.

In one aspect, a program product includes but is not limited to: a signal bearing medium bearing one or more instructions for displaying a limited-use electronic mail account interface to create a limited-use electronic mail account, and one or more instructions for accepting input to the limited-use electronic mail account interface. In addition to the foregoing, other program product aspects are described in the claims, drawings, and text forming a part of the present application.

In one aspect, a method related to electronic mail includes but is not limited to accepting input from a limited-use electronic mail account interface to create a limited-use electronic mail account; and transmitting a signal related to a creation of the limited-use electronic mail account. In addition to the foregoing, other method aspects are described in the claims, drawings, and text forming a part of the present application.

In one aspect, a system related to electronic mail includes but is not limited to circuitry for accepting input from a limited-use electronic mail account interface to create a limited-use electronic mail account; and circuitry for transmitting a signal related to a creation of the limited-use electronic mail account. In addition to the foregoing, other system aspects are described in the claims, drawings, and text forming a part of the present application.

In one or more various aspects, related systems include but are not limited to circuitry and/or programming and/or electro-mechanical devices and/or optical devices for effecting the herein-referenced method aspects; the circuitry and/or programming and/or electro-mechanical devices and/or optical devices can be virtually any combination of hardware, software, and/or firmware configured to effect the herein-referenced method aspects depending upon the design choices of the system designer skilled in the art.

In one aspect, a program product includes but is not limited to a signal bearing medium bearing one or more instructions for accepting input from a limited-use electronic mail account interface to create a limited-use electronic mail account; and one or more instructions for transmitting a signal related to a creation of the limited-use electronic mail account. In addition to the foregoing, other program product aspects are described in the claims, drawings, and text forming a part of the present application.

In one aspect, a method related to electronic mail includes but is not limited to receiving a signal related to a creation of a limited-use electronic mail account; and creating the limited-use electronic mail account. In addition to the foregoing, other method aspects are described in the claims, drawings, and text forming a part of the present application.

In one aspect, a system related to electronic mail includes but is not limited to circuitry for receiving a signal related to a creation of a limited-use electronic mail account; and circuitry for creating the limited-use electronic mail account. In addition to the foregoing, other system aspects are described in the claims, drawings, and text forming a part of the present application.

In one or more various aspects, related systems include but are not limited to circuitry and/or programming and/or electro-mechanical devices and/or optical devices for effecting the herein-referenced method aspects; the circuitry and/or programming and/or electro-mechanical devices and/or optical devices can be virtually any combination of hardware, software, and/or firmware configured to effect the herein-referenced method aspects depending upon the design choices of the system designer skilled in the art.

In one aspect, a program product includes but is not limited to a signal bearing medium bearing one or more instructions for receiving a signal related to a creation of a limited-use electronic mail account; and one or more instructions for creating the limited-use electronic mail account. In addition to the foregoing, other program product aspects are described in the claims, drawings, and text forming a part of the present application.

In addition to the foregoing, various other method and/or system and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 depicts one implementation of an exemplary environment in which the methods and systems described herein may be represented;

FIG. 2 depicts a high-level logic flowchart of an operational process;

FIG. 3 illustrates several alternative implementations of the high-level logic flowchart of FIG. 2;

FIG. 4 shows several alternate implementations of the high-level logic flowchart of FIG. 2;

FIG. 5 depicts a high-level logic flowchart of an operational process;

FIG. 6 illustrates several alternate implementations of the high-level logic flowchart of FIG. 5;

FIG. 7 depicts a high-level logic flowchart of an operational process; and

FIG. 8 illustrates several alternate implementations of the high-level logic flowchart of FIG. 7.

The use of the same symbols in different drawings typically indicates similar or identical items.

### DETAILED DESCRIPTION

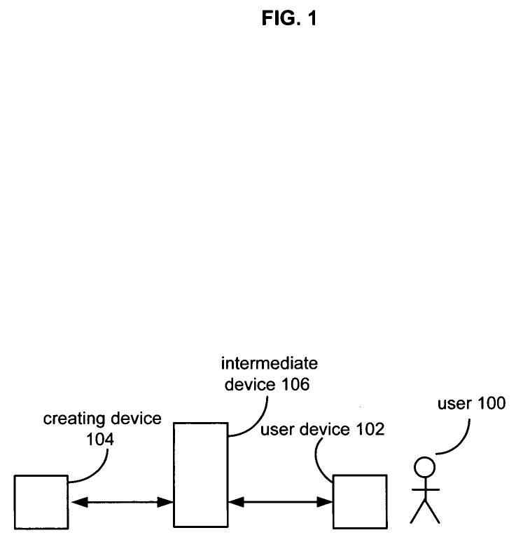

With reference to the figures, FIG. 1 depicts one implementation of an exemplary environment in which the methods and systems described herein may be represented. The user 100 is a user who initiates creation of a limited-use electronic mail account. The user 100 uses user device 102, which may be a wireless handheld device, a laptop computer, a personal computer, a computer system terminal, or any other device capable of displaying a limited-use electronic mail account interface to create a limited-use electronic mail account and of accepting input to the limited-use electronic mail account interface. User device 102 may also be a wireless handheld device, a laptop computer, a personal computer, a computer system terminal, or any other device capable of accepting input from a limited-use electronic mail account interface to create a limited-use electronic mail account and of transmitting a signal related to a creation of the limited-use electronic mail account.

Creating device 104 is a device with which a limited-use electronic mail account may be created. Creating device 104 is exemplary of substantially any and all devices that may provide computational resources, e.g., one or more system servers and/or transmission media, to create a limited-use electronic mail account. Creating device 104 may a wireless handheld device, a laptop computer, a personal computer, a computer system terminal, or any other device capable of receiving a signal related to a creation of a limited-use electronic mail account and of creating the limited-use electronic mail account. Intermediate device 106 is exemplary of substantially any and all intermediate devices that may provide paths and/or computational resources, e.g., one or more electronic mail servers and/or transmission media, to carry signals related to a creation of a limited-use electronic mail account from the user device 102 to the creating device 104.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

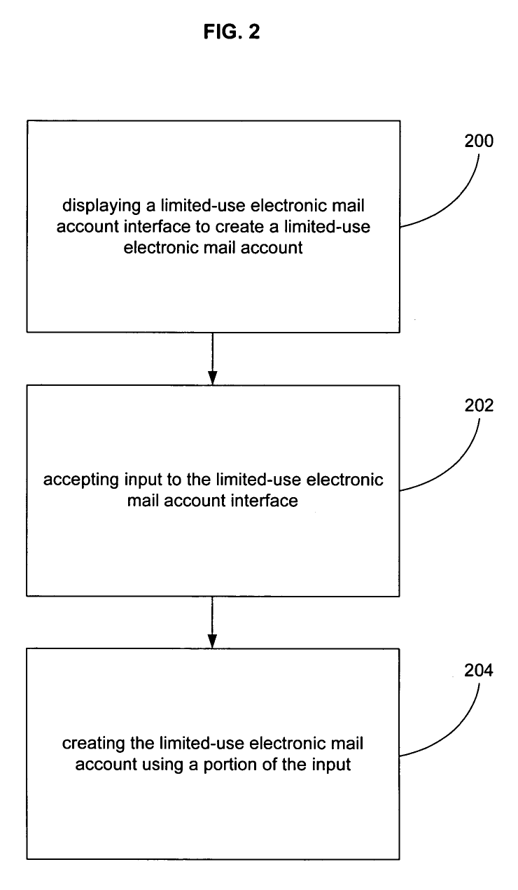

FIG. 2 depicts a high-level flowchart of an operational process. Operation 200 shows displaying a limited-use electronic mail account interface to create a limited-use electronic mail account. Operation 202 depicts accepting input to the limited-use electronic mail account interface. Operation 204 illustrates creating the limited-use electronic mail account using a portion of the input. The exemplary environment of FIG. 1 can serve to illustrate examples of operations described herein. In one example, illustrating operation 200, the user 100 is presented with a display of a limited-use electronic mail account interface on the device 102. The user 100 inputs data related to the creation of a limited-use electronic mail account, e.g., a user name, to the limited-use electronic mail account interface. In one example, illustrating operation 202, the limited-use electronic mail account interface accepts the data input by the user 102. In one example, illustrating operation 204, the creating device 104 creates the limited-use electronic mail account using a portion of the input accepted in operation 202. The intermediate device 106 may be used to carry the input from the user device 102 to the creating device 104.

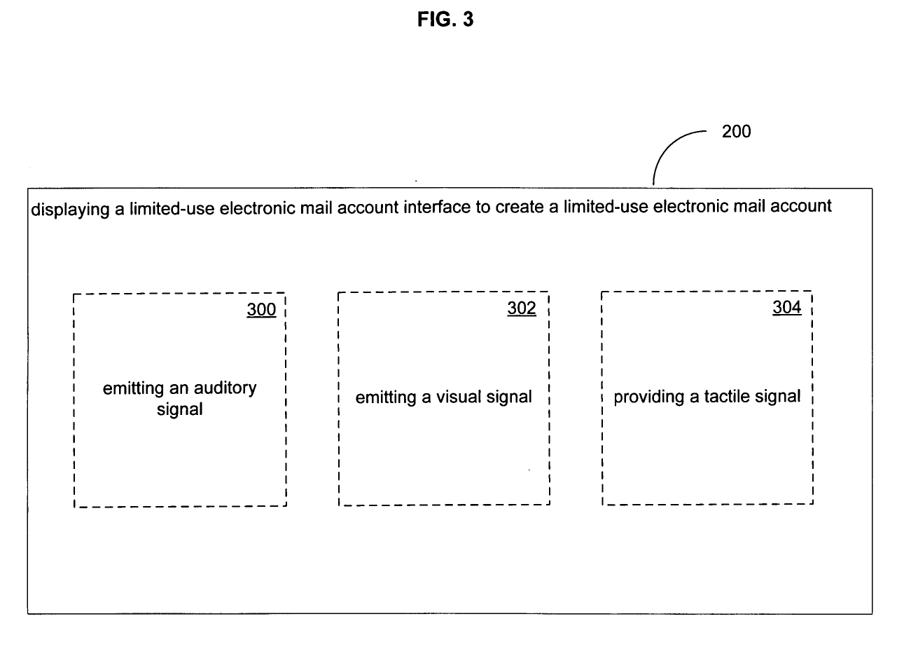

FIG. 3 illustrates several alternate implementations of the high-level logic flowchart of FIG. 2. Depicted is that in one alternative implementation, operation 200—displaying a limited-use electronic mail account interface to create a limited-use electronic mail account—includes one or more operations 300, 302, and/or 304. Operation 300 depicts emitting an auditory signal (e.g., the user device 102 emitting a ring tone to notify the user 100 that a limited-use electronic mail account interface is available to accept input, or the user device 102 issuing automated voice instructions to solicit input from the user 100). Operation 302 shows emitting a visual signal (e.g., the user device 102 showing a graphical user interface implementation of a limited-use electronic mail account interface on a display screen). Operation 304 illustrates providing a tactile signal (e.g., activating a vibrating notification feature of the user device 102 such as a personal wireless device to notify the user 100 that a limited-use electronic mail account interface is available to accept input, or the user device 102 soliciting instructions via a tactile interface, such as a tactile Braille interface for the visually-impaired).

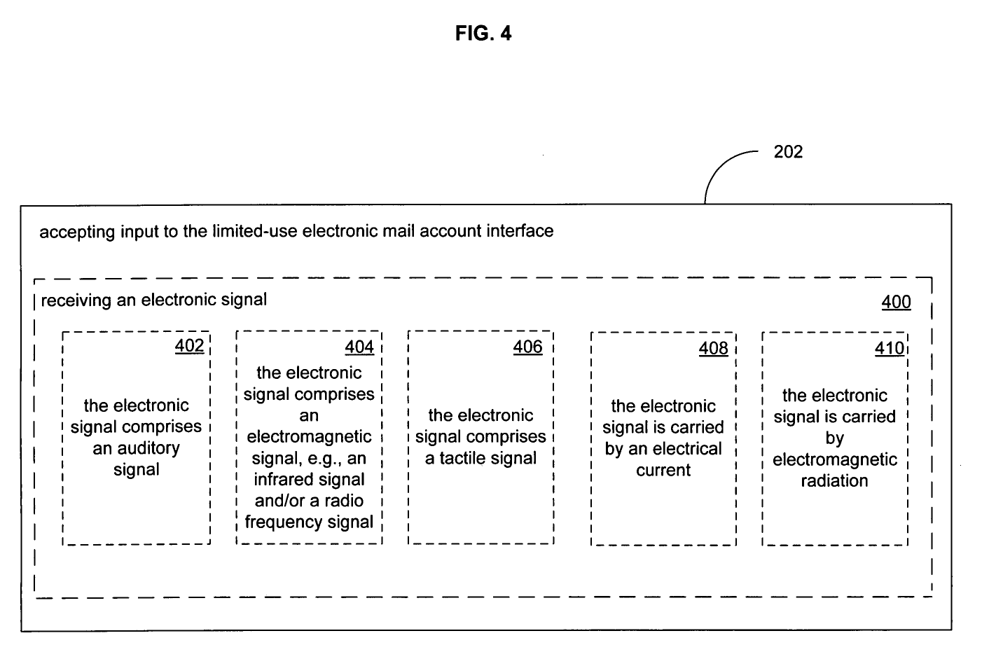

FIG. 4 shows several alternative implementations of the high-level logic flowchart of FIG. 2. Depicted is that in one alternative implementation, operation 202—accepting input to the limited-use electronic mail account interface—includes operation 400, which illustrates receiving an electronic signal (e.g., the user device 102 receives an electronic signal using hardware/firmware/software embodied logic of the user device 102). Shown is that in other alternative implementations, operation 400 may include one or more of operations 402, 404, 406, 408, and 410. Operation 402 depicts the electronic signal of operation 400 comprising an auditory signal (e.g., the user 100 speaks input to the user device 102 and the auditory input of user 100 is rendered into an electronic signal comprising the auditory input by hardware/firmware/software embodied logic of the user device 102). Operation 404 depicts the electronic signal of operation 400 comprising an electromagnetic signal (e.g., the user 100 enters input to the user device 102 with an infrared device, and the infrared signal from the infrared device is rendered into an electronic signal comprising the visual input by hardware/firmware/software embodied logic of the user device 102, or the user 100 enters input to the user device 102 with a device using radio frequency electromagnetic radiation, and the radio frequency signal from the radio frequency device is rendered into an electronic signal comprising the visual input by hardware/firmware/software embodied logic of the user device 102). Operation 406 depicts the electronic signal of operation 400 comprising a tactile signal (e.g., the user 100 enters input to the user device 102 via a keyboard, keypad, or touchscreen and the tactile input of the user 100 is rendered into an electronic signal comprising the tactile input by hardware/firmware/software embodied logic of the user device 102). Operation 408 depicts the electronic signal of operation 400 being carried by an electrical current (e.g., the electronic signal is carried by a current over an electrical wire). Operation 408 depicts the electronic signal of operation 400 being carried by electromagnetic radiation (e.g., the electronic signal is carried by a wireless link at, e.g., infrared frequencies or radio frequencies).

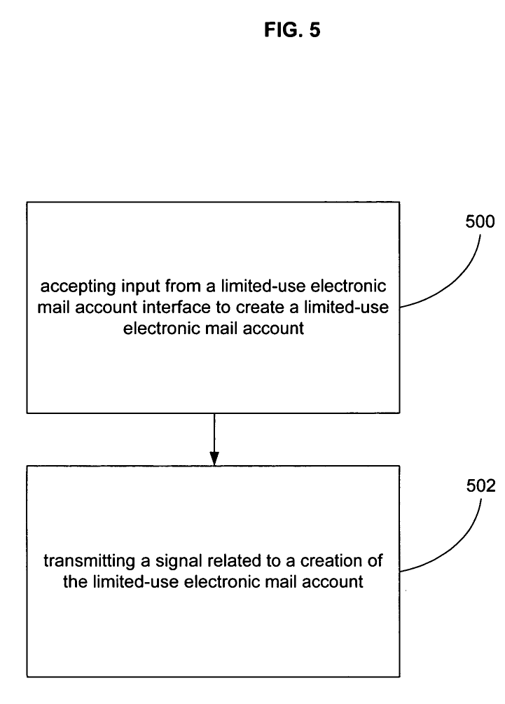

FIG. 5 depicts a high-level flowchart of an operational process. Operation 500 shows accepting input from a limited-use electronic mail account interface to create a limited-use electronic mail account (e.g., using hardware/firmware/software embodied logic of the user device 102, the user device 102 accepts from the user 100 input related to the creation of a limited-use electronic mail account from a limited-use electronic mail account interface associated with the user device 102). Operation 502 depicts transmitting a signal related to a creation of the limited-use electronic mail account (e.g., using hardware/firmware/software embodied logic of the user device 102, the user device 102 transmits a signal related to a creation of the limited-use electronic mail account to the creating device 104, either directly or via intermediate device 106).

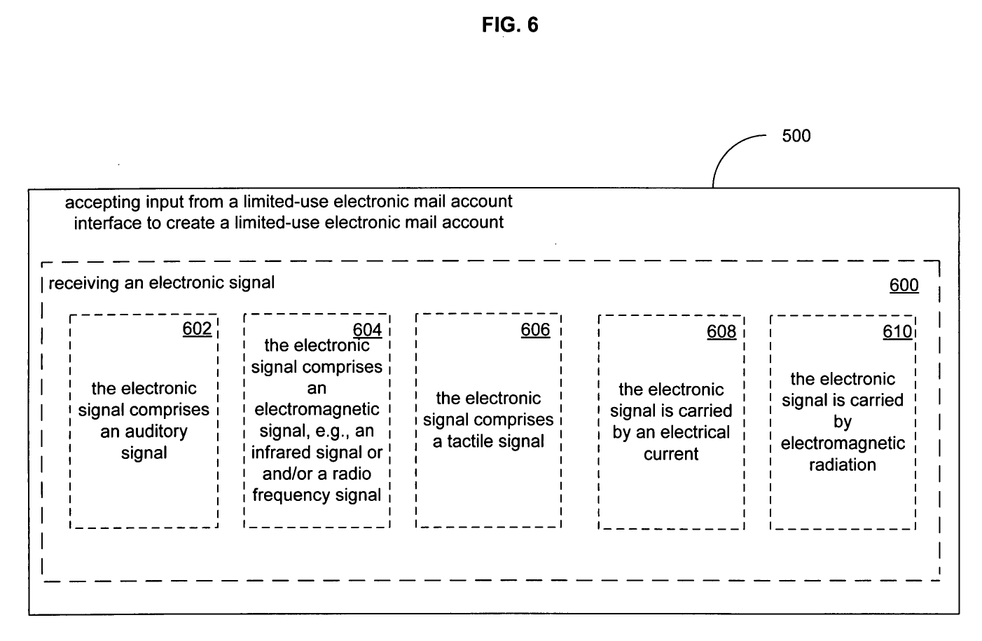

FIG. 6 illustrates several alternate implementations of the high-level logic flowchart of FIG. 5. Depicted is that one alternative implementation, operation 500—accepting input from a limited-use electronic mail account interface to create a limited-use electronic mail account—includes operation 600, which illustrates receiving an electronic signal (e.g., the user device 102 that displays a limited-use electronic mail account interface, such as a graphical user interface displayed on a screen, has hardware/firmware/software embodied logic that is used to accept input entered by the user 100 via the limited-use electronic mail account interface). Shown is that in alternative implementations, operation 600 may include one or more of the operations 602, 604, 606, 608, and/or 610. Operation 602 depicts the electronic signal of operation 500 comprising an auditory signal (e.g., the user 100 speaks input to the user device 102 and the auditory input of user 100 is rendered into an electronic signal comprising the auditory input by hardware/firmware/software embodied logic of the user device 102). Operation 604 depicts the electronic signal of operation 500 comprising an electromagnetic signal (e.g., the user 100 enters input to the user device 102 with an infrared device, and the infrared signal from the infrared device is rendered into an electronic signal comprising the visual input by hardware/firmware/software embodied logic of the user device 102, or the user 100 enters input to the user device 102 with a device using radio frequency electromagnetic radiation, and the radio frequency signal from the radio frequency device is rendered into an electronic signal comprising the visual input by hardware/firmware/software embodied logic of the user device 102). Operation 606 depicts the electronic signal of operation 500 comprising a tactile signal (e.g., the user 100 enters input to the user device 102 via a keyboard, keypad, or touchscreen and the tactile input of the user 100 is rendered into an electronic signal comprising the tactile input by hardware/firmware/software embodied logic of the user device 102). Operation 608 depicts the electronic signal of operation 500 being carried by an electrical current (e.g., the electronic signal is carried by a current over an electrical wire). Operation 610 depicts the electronic signal of operation 500 being carried by electromagnetic radiation (e.g., the electronic signal is carried by a wireless link at, e.g., infrared frequencies or radio frequencies).

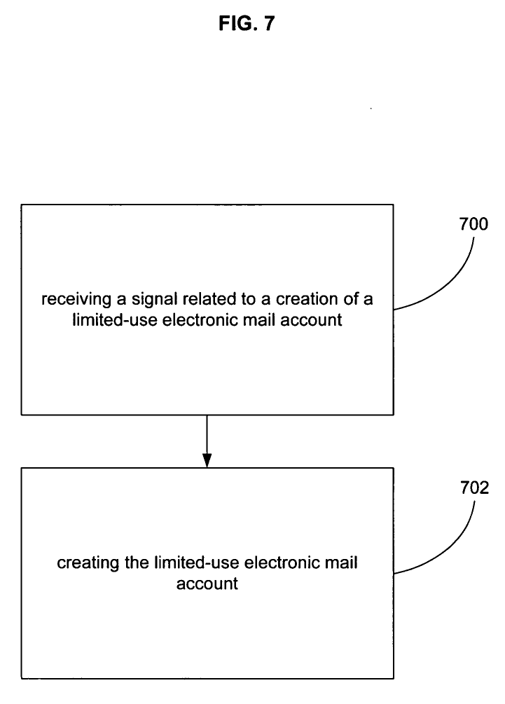

FIG. 7 depicts a high-level flowchart of an operational process. Operation 700 shows receiving a signal related to a creation of a limited-use electronic mail account (e.g., using hardware/firmware/software embodied logic of the creating device 104, the creating device 104 receives from the user device 102, either directly or via intermediate device 106, a signal related to the creation of a limited-use electronic mail account). Operation 702 depicts creating the limited-use electronic mail account (e.g., using hardware/firmware/software embodied logic of the creating device 104, the creating device 104 creates a limited-use electronic mail account using a portion of the signal received from the user device 102 in operation 700).

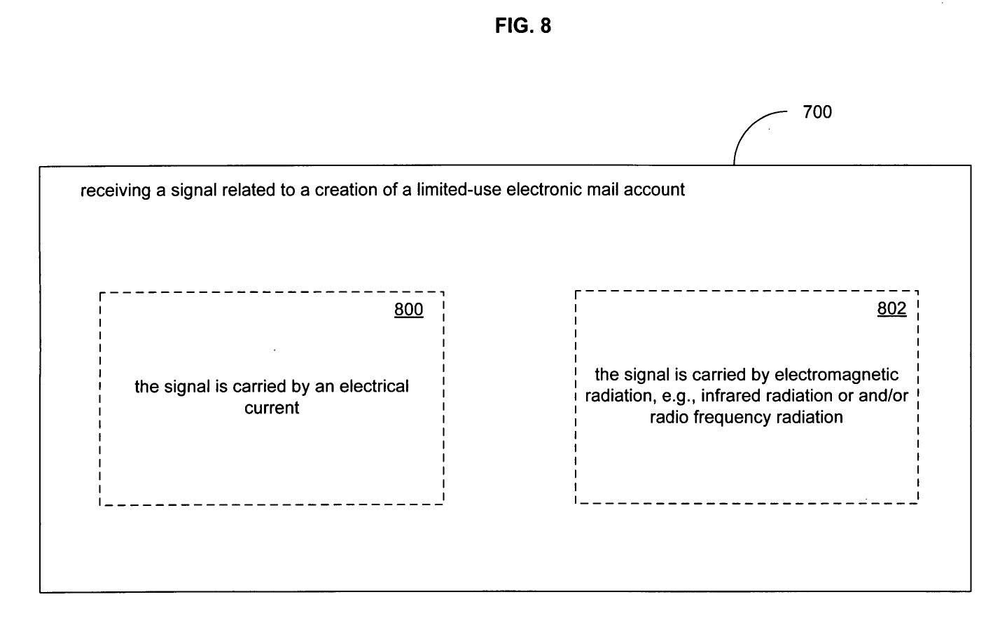

FIG. 8 illustrates several alternate implementations of the high-level logic flowchart of FIG. 7. Depicted is that one alternative implementation, operation 700—receiving a signal related to a creation of a limited-use electronic mail account—includes one or both of operation 800, which illustrates the received signal being carried by an electrical current (e.g., the received signal is carried via an electrical wire from the user device 102, either directly or via intermediate device 106, to the creating device 104, which receives the signal using hardware/firmware/software embodied logic of the creating device 104), and operation 802, which illustrates the received signal being carried by electromagnetic radiation (e.g. the received signal is carried via wireless electromagnetic radiation such as an infrared radiation or a radio frequency radiation from the creating device 104, either directly or via intermediate device 106, to the creating device 104, which receives the signal using hardware/firmware/software embodied logic of the creating device 104).

Those skilled in the art will appreciate that the herein-described specific processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use standard engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

1. A method related to electronic mail, the method comprising:
displaying a limited-use electronic mail account interface to create a limited-use electronic mail account; and
accepting input to the limited-use electronic mail account interface.

2. The method of claim 1, further comprising:
creating the limited-use electronic mail account using a portion of the input.

3. The method of claim 1, wherein the displaying a limited-use electronic mail account interface to create a limited-use electronic mail account comprises:
emitting an auditory signal.

4. The method of claim 1, wherein the displaying a limited-use electronic mail account interface to create a limited-use electronic mail account comprises:
emitting a visual signal.

5. The method of claim 1, wherein the displaying a limited-use electronic mail account interface to create a limited-use electronic mail account comprises:
providing a tactile signal.

6. The method of claim 1, wherein the accepting input to the limited-use electronic mail account interface comprises:
receiving an electronic signal.

7. The method of claim 6, wherein the electronic signal comprises:
an auditory signal.

8. The method of claim 6, wherein the electronic signal comprises:
an electromagnetic signal.

9. The method of claim 8, wherein the electromagnetic signal comprises:
an infrared signal.

10. The method of claim 8, wherein the electromagnetic signal comprises:
a radio frequency signal.

11. The method of claim 6, wherein the electronic signal comprises:
a tactile signal.

12. (canceled)

13. (canceled)

14. A system related to electronic mail, the system comprising:
circuitry for displaying a limited-use electronic mail account interface to create a limited-use electronic mail account; and
circuitry for accepting input to the limited-use electronic mail account interface.

15. The system of claim 14, further comprising:
circuitry for creating the limited-use electronic mail account using a portion of the input.

16. The system of claim 14, wherein the circuitry for displaying a limited-use electronic mail account interface to create a limited-use electronic mail account comprises:
circuitry for emitting an auditory signal.

17. The system of claim 14, wherein the circuitry for displaying a limited-use electronic mail account interface to create a limited-use electronic mail account comprises:
circuitry for emitting a visual signal.

18. The system of claim 14, wherein the circuitry for displaying a limited-use electronic mail account interface to create a limited-use electronic mail account comprises:
circuitry for providing a tactile signal.

19. The system of claim 14, wherein the circuitry for accepting input to the limited-use electronic mail account interface comprises:
circuitry for receiving an electronic signal.

20. The system of claim 19, wherein the circuitry for accepting input to the limited-use electronic mail account interface comprises:
circuitry for receiving a signal carried by an electrical current.

21. The system of claim 19, wherein the circuitry for accepting input to the limited-use electronic mail account interface comprises:
circuitry for receiving a signal carried by electromagnetic radiation.

22. The system of claim 14, wherein the circuitry for accepting input to the limited-use electronic mail account interface comprises:
circuitry for receiving an auditory signal.

23. The system of claim 14, wherein the circuitry for accepting input to the limited-use electronic mail account interface comprises:
circuitry for receiving a visual signal.

24. The system of claim 14, wherein the circuitry for accepting input to the limited-use electronic mail account interface comprises:
circuitry for receiving a tactile signal.

25. (canceled)

26. (canceled)

27. A program product comprising:
a signal bearing medium bearing
one or more instructions for displaying a limited-use electronic mail account interface to create a limited-use electronic mail account, and
one or more instructions for accepting input to the limited-use electronic mail account interface.

28. The program product of claim 27, further comprising:
one or more instructions for creating the limited-use electronic mail account using a portion of the input.

29. The program product of claim 27, wherein the signal bearing medium comprises:
a recordable medium.

30. The program product of claim 27, wherein the signal bearing medium comprises:
a transmission medium.

31. A method relating to electronic mail, the method comprising:
accepting input from a limited-use electronic mail account interface to create a limited-use electronic mail account; and
transmitting a signal related to a creation of the limited-use electronic mail account.

32. (canceled)

33. (canceled)

34. (canceled)

35. (canceled)

36. (canceled)

37. (canceled)

38. (canceled)

39. (canceled)

40. (canceled)

41. A system comprising:
means for accepting input from a limited-use electronic mail account interface to create a limited-use electronic mail account; and
means for transmitting a signal related to a creation of the limited-use electronic mail account.

42. A program product comprising:
a signal bearing medium bearing
one or more instructions for accepting input from a limited-use electronic mail account interface to create a limited-use electronic mail account, and
one or more instructions for transmitting a signal related to a creation of the limited-use electronic mail account.

43. The program product of claim 42, wherein the signal bearing medium comprises:
a recordable medium.

44. The program product of claim 42, wherein the signal bearing medium comprises:
a transmission medium

45. (canceled)

46. (canceled)

47. (canceled)

48. (canceled)

49. (canceled)

50. (canceled)

51. (canceled)

52. (canceled)

53. (canceled)

54. (canceled)
